(19) United States
(12) Patent Application Publication
(10) Pub. No.: US 2015/0210108 A1
(43) Pub. Date: Jul. 30, 2015

(54) METHOD FOR THE REALIZATION OF A MOSAIC FOR COVERING WALLS, FLOORS AND THE LIKE

(71) Applicant: LEO VISCONTI S.R.L., Spilamberto (MO) (IT)

(72) Inventor: Raffaele Morini, Spilamberto (MO) (IT)

(21) Appl. No.: 14/429,841

(22) PCT Filed: Sep. 19, 2013
(86) PCT No.: PCT/IB2013/058674

§ 371 Date: Mar. 20, 2015

(30) Foreign Application Priority Data
Sep. 21, 2012 (IT) MO2012A000227

(51) Int. Cl. B44C 3/12; E04F 15/02

(52) U.S. Cl. CPC B44C 3/123; E04F 15/02

(57) ABSTRACT

A method for the realization of a mosaic for covering walls, floors and the like, includes the following steps:
melting a nitrous material;
pouring a predefined quantity of the melted material (M) into a containment mould (4) shaped so as to define a substantially sheet-shaped article;
deforming the sheet-shaped article (5), while being in a plastic type state, so as to define a plurality of grooves (6) intersecting one another;
cutting the sheet-shaped article (5) thus deformed along the grooves (6) so as to obtain a plurality of tesserae (3); and
applying the tesserae (3) onto at least a supporting element (2) to define a mosaic (1).

### TECHNICAL FIELD

The present invention relates to a method for the realization of a mosaic for covering walls, floors and the like.

### BACKGROUND ART

As is known, by the term mosaic is meant a whole plurality of material fragments which can be of various nature, i.e., ceramic, glass, natural stones, etc., called in jargon “tesserae”, which are arranged on a support surface in such a way as to reproduce a particular figure or design. The realization of the mosaic is mainly done using two methods called direct and indirect respectively.

The direct method envisages the application of an adhesive layer on the areas to be worked and the subsequent positioning of the tesserae on such adhesive layer.

The indirect method envisages, instead, the positioning of the tesserae wrong side up on a temporary support, in such a way as to obtain a flat surface. Subsequently, the whole is glued on the definitive support surface and the temporary support is removed.

To date, various technologies have been used to realize mosaics, and in particular the tesserae making them up.

Such technologies generally vary according to the material used. For example, in the case of tesserae made of vitreous material, the production technology is of the artisan type and envisages the manual realization of the tesserae, one by one.

As it is easy to appreciate, this translates into long production times, which inevitably affect the cost of the end product.

Furthermore, the correct realization of the tesserae and, therefore, the final result of the mosaic, are strongly affected by operator skills.

In the case of tesserae made of ceramic material, the use is currently widespread of presses with a special mould suitable for forming the above-mentioned tesserae, which subsequently have to undergo a firing process.

This technology permits obtaining high productivity, while at the same time disassociating the quality of the end product from the operator skills, but does not appear suitable for working vitreous material which, as is known, in its fluid state reaches temperatures of around 1200° C.

### DESCRIPTION OF THE INVENTION

The main aim of the present invention is to provide a method for the realization of a mosaic which allows considerably cutting production times compared to the methods used to date for the formation of tesserae in vitreous material.

Within this aim, one object of the present invention is to cut production costs and, therefore, also the cost of the finished product.

Another object of the present invention is to disassociate as much as possible the correct realization of the tesserae from the skills and experience of the operator.

Another object of the present invention is to provide a method for the realization of a mosaic for covering walls, floors and the like which allows overcoming the mentioned drawbacks of the state of the art within the ambit of a simple, rational, easy, effective to use and low cost solution.

The above mentioned objects are achieved by the present breaking device of a trailer according to claim 1.

### BRIEF DESCRIPTION OF THE DRAWINGS

Other characteristics and advantages of the present invention will become more evident from the description of a preferred, but not sole, embodiment of a method for the realization of a mosaic for covering walls, floors and the like, illustrated purely as an example but not limited to the annexed drawings in which:

FIG. 1 is an axonometric view of a mosaic obtained with a method according to the invention;

FIG. 2 is a schematic view of the pouring phase of a predefined quantity of a melted material into a containment mould to obtain a sheet-shaped article;

FIG. 3 is a schematic view of the deformation phase of the sheet-shaped article;

FIG. 4 is a schematic view of the sheet-shaped article at the end of the deformation phase;

FIG. 5 is a schematic view of the cooling phase of the sheet-shaped article thus deformed;

FIG. 6 is a schematic view of the cutting phase of the sheet-shaped article to obtain a plurality of tesserae;

FIG. 7 is a schematic view of the application phase of the tesserae on a supporting element.

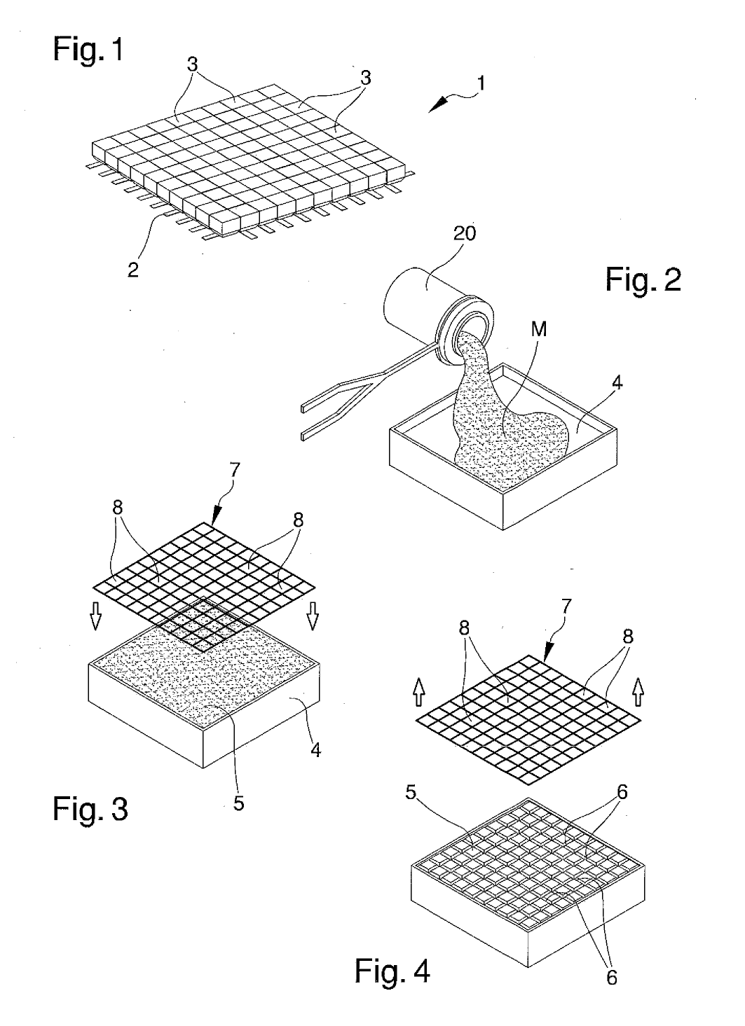

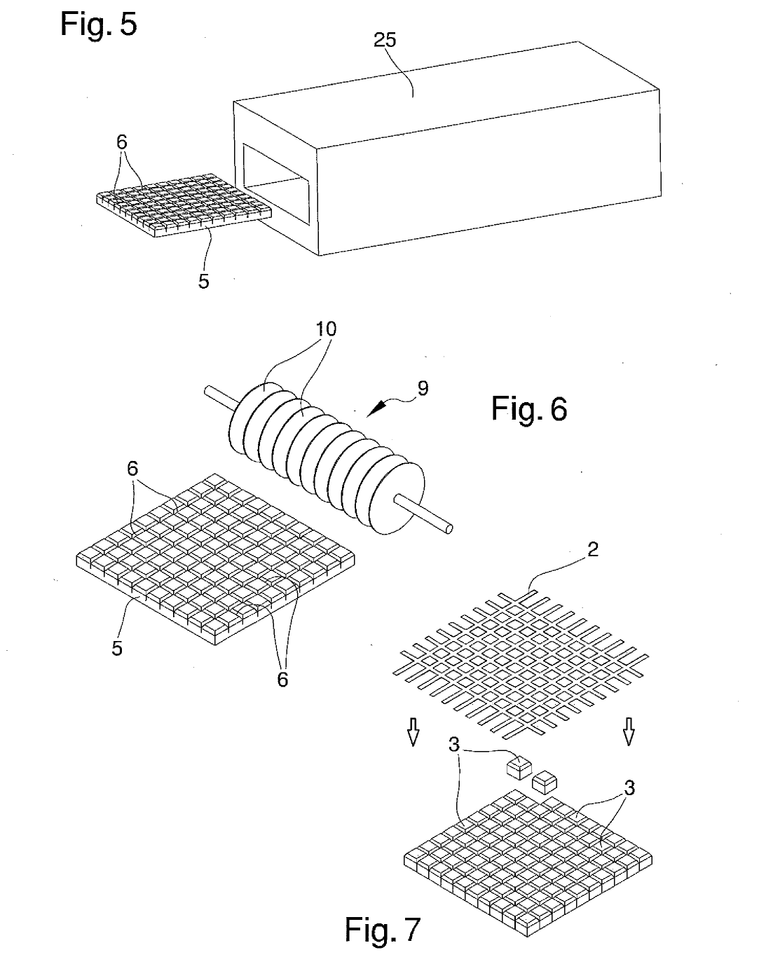

### EMBODIMENTS OF THE INVENTION

With particular reference to such figures, globally indicated by 1 is a mosaic obtained with the method according to the invention.

The mosaic 1 comprises a supporting element 2 on which is applied a plurality of tesserae 3.

The method for the realization of a mosaic for covering walls, floors and the like, first of all envisages a melting phase of a vitreous-base material.

This phase is mostly performed by placing the material to be melted in a crucible 20 and bringing it up to melting temperature, the latter depending on the particular composition used (generally between 1000° C. and 1300° C.).

Subsequently, a predefined quantity of the work material in melted state is taken, indicated in FIG. 2 by the letter M, and this is poured into a containment mould, identified in the illustrations by the reference number 4.

The mould 4 is shaped in such a way as to define a substantially sheet-shaped article. By the term sheet-shaped is meant an article having two dimensions, length and width, which are prevalent with respect to the third, i.e., the thickness.

The mould 4 can therefore be shaped like a parallelepiped and has a substantially constant depth, e.g., between 6 mm and 20 mm, preferably equal to about 10 mm. The dimensions of the mould 4 vary suitably according to the number and the dimensions of the tesserae 3 to be obtained.

Following the pouring of the melted material M into the mould 4, a sheet-shaped article is formed, identified by the reference number 5, which is plastically deformable. In fact, although after been poured into the mould 4, the temperature of the melted material M generally drops by about 200° C.-300° C., the sheet-shaped article 5 thus obtained is still in semi-liquid state and is therefore of the plastic type.

The sheet-shaped article 5 thus obtained is then deformed so as to define a plurality of grooves 6 intersecting one another.

Preferably, the grooves 6 are of the straight type.

In the preferred, but not exclusive embodiment shown in the FIGS. 3 and 4, the deformation phase of the sheet-shaped article 5 is performed by impressing a grid-shaped element 7 on a face of the article itself.

More in particular, the sheet-shaped article 5 has a face arranged resting on the mould 4 and a visible face turned towards the outside. During the deformation phase, the grid-shaped element 7 is therefore pressed against the visible face of the sheet-shaped article 5 and made to penetrate inside this to a certain depth, in any case less than the thickness of the sheet-shaped article.

The deformation phase is then performed with the sheet-shaped article 5 still inside the mould 4, which thus acts as a support.

The grid-shaped element 7 can be made of metal material or, alternatively, of polymer material.

More in detail, the grid-shaped element 7 has a plurality of openings 8 having the dimensions of the tesserae to be obtained.

Preferably, the openings 8 are parallelepiped shaped.

Following the pressure applied on the sheet-shaped article 5 to make the grooves 6, the visible face of same is deformed and curves outwards.

Advantageously, at the end of the deformation phase described above, a cooling phase is performed of the sheet-shaped article 5 thus defaulted.

More in particular, this cooling phase is of the controlled type so as to prevent the formation of stresses inside the article caused by a too-sudden drop in its temperature.

In this respect, the controlled cooling phase, e.g., performed by means of a so-called blast furnace 25, envisages a drop in temperature down to about 50° C. in a time interval of substantially between 2 and 6 hours depending on the thickness of the sheet-shaped article 5. More in detail, the temperature of the sheet-shaped article 5 at the end of the deformation phase is about 800° C., and consequently, during the cooling phase, this undergoes a drop of about 700° C.-750° C. in the aforementioned time interval.

At the end of the cooling phase, the sheet-shaped article 5 is therefore in solid state and is no longer plastically deformable.

Once the controlled cooling phase is over, the sheet-shaped article 5 is cut so as to obtain a plurality of tesserae 3.

Such cutting phase is performed along the grooves 6, which besides representing the geometric limit of each tessera 3 also define the cutting guidelines.

More in detail, the grooves 6, thanks to their reduced thickness, define corresponding weakened areas of the sheet-shaped article 5 which, besides facilitating the breakage of same, also ensure the correct cutting line is maintained.

In a preferred embodiment, the sheet-shaped article is cut by means of a tool 9 having a plurality of cutting blades 10 spaced out from each other.

The distance of the cutting blades 10 can be fixed and substantially corresponding to the width of the tesserae 3, or be adjustable from time to time by the operator.

Once the cutting phase is over, the tesserae 3 thus obtained are fitted on a supporting element 2.

Such supporting element 2 is preferably made of a reticular glass-fibre sheet onto which the tesserae 3 are glued to obtain the mosaic 1.

It has in practice been ascertained how the described invention achieves the proposed object and in particular the fact is underlined that the method in question allows obtaining a mosaic made of vitreous material in a considerably simpler and faster way compared to currently known methods.

The method forming the subject of the present invention does in fact allow making a plurality of tesserae in vitreous material by means of the machining of a single sheet-shaped article.

Furthermore, the method according to the invention envisages a small number of phases which, besides cutting manufacturing times, also allow considerably reducing the impact of the operator's skill and experience on the end result compared to the known glass mosaic creation method.

The claimed method thus permits making a mosaic in vitreous material in a very short time and in a way that is reproducible over time.

1-10. (canceled)

11. Method for the realization of a mosaic for covering walls, floors and the like, wherein it comprises the following phases of:
melting a nitrous material;
pouring a predefined quantity of said melted material (M) into a containment mould (4) shaped so as to define a substantially sheet-shaped article;
deforming said sheet-shaped article (5), while being in a plastic type state, so as to define a plurality of grooves (6) intersecting one another;
cutting said sheet-shaped article (5) thus deformed along said grooves (6) so as to obtain a plurality of tesserae (3);
applying said tesserae (3) onto at least a supporting element (2) to define a mosaic (1).

12. A method according to claim 11, wherein once said pouring has been completed, the temperature of said sheet-shaped article (5) is between 800° C. and 1000° C.

13. A method according to claim 11, wherein said mould (4) has a depth between 6 mm and 20 mm.

14. A method according to claim 11, wherein said deformation is performed when said sheet-shaped article (5) is in semi-liquid state.

15. A method according to claim 11, wherein said grooves (6) are of the straight type.

16. A method according to claim 11, wherein said deformation is performed by impressing a grid-shaped element (7) on a face of said sheet-shaped article (5).

17. A method according to claim 11, wherein said deformation is performed inside said mould (4).

18. A method according to claim 11, wherein it comprises a cooling phase of said sheet-shaped article (5) at the end of said deformation.

19. A method according to claim 18, wherein said cooling is of the controlled type.

20. A method according to claim 19, wherein said controlled cooling contemplates the drop in temperature to approx. 50° C. in a time interval between 2 hours and 6 hours.
